(19) United States
(12) Patent Application Publication
(10) Pub. No.: US 2008/0263447 A1
(43) Pub. Date: Oct. 23, 2008

(54) SYSTEM AND METHOD FOR AUDIOVISUAL CONTROL OF DOCUMENT PROCESSING DEVICES

(76) Inventors: Man Mohan GARG, Cerritos, CA (US); Ajit SODHI, Irvine, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/736,987

(22) Filed: Apr. 18, 2007

(51) Int. Cl. G06F 3/00

(52) U.S. Cl. 715/716

(57) ABSTRACT

The subject application is directed to a system and method for audiovisual control of a document processing device. First level graphical images are generated on a display, with each image representing an available first level document processing operation capable of being performed by a document processing device. First audible speech information is received from a user of a selected first level operation. The selected first level operation is isolated according to the received first audible speech information. Second level graphical images are then generated on the display, with each second level image representing a second level document processing operation of the first level operation. Second audible speech information is received from the user of a second level operation. The second level operation is isolated according to the received second audible speech information. A document processing operation is commenced according to the first level operation and the second level operation.

### BACKGROUND OF THE INVENTION

The subject application is directed generally to the control of document processing devices. More particularly, the subject application is directed to a system and method for efficient user control via a hybridized hierarchical user interface employing speech and graphical user interface input. It will be appreciated, however, that the teachings herein are advantageously used in any system and method wherein efficient and uncomplicated device control is desirable.

Document processing devices include functions such as copying, facsimile transmission, scanning, electronic mail, and storage. These functions, as well as additional functions which are continually being added to office machines, are often combined in a single apparatus, sometimes referred to as multifunction peripheral devices.

Given the many and varied options associated with control of document processing devices, modern devices often employ a graphical user interface. Such interfaces may provide visual depictions of various functions or controls. In a touch screen embodiment, a user suitably reviews functions, and selects them by touching an icon corresponding to the desired function.

Advances in speech recognition technology have also given rise to products employing voice control. Voice control is advantageous for selected applications. However, for other applications, a more traditional graphical user interface may be better suited. Also, certain users may prefer one type of interface over another, or they may have differing preferences for control of various functions.

### SUMMARY OF THE INVENTION

In accordance with one embodiment of the subject application, there is provided a system and method for controlling a document processing device.

Further, in accordance with one embodiment of the subject application, there is provided a system and method for the audiovisual control of a document processing device.

Still further, in accordance with one embodiment of the subject application, there is provided a system and method for efficient user control via a hybridized hierarchical user interface employing speech and graphical user interface input.

Further, in accordance with one embodiment of the subject application, there is provided a system for audiovisual control of a document processing device. The system comprises means adapted for generating, on an associated video display terminal, a plurality of first level graphical images, wherein each first level graphical image is uniquely representative of at least one of a plurality of available first level document processing operations. The system also includes means adapted for receiving first audible speech information from an associated user, which first audible speech information corresponds to a selected one of the available first level document processing operations and recognition means, wherein the recognition means includes means adapted for isolating the selected one of the available first level document processing operations in accordance with received first audible speech information. The system further comprises means adapted for generating, on the associated video display terminal, a plurality of second level graphical images, each second level graphical image being uniquely representative of a least one of a plurality of available second level document processing operations corresponding to the selected first level document processing operation. The system further includes means adapted for receiving second audible speech information from the associated user, which second audible speech information corresponds to a selected one of the available second level document processing operations and wherein the recognition means further includes means adapted for isolating the selected one of the available second level document processing operations in accordance with received second audible speech information. The system further comprises means adapted for commencing a document processing operation on an associated document in accordance with an output of the recognition means.

In one embodiment of the subject application, the system further comprises means adapted for receiving non-audible user selection data corresponding to each of the selected first level document processing operation and the second level document processing operation such that the associated user is enabled for alternative selection via audible and non-audible input.

In another embodiment of the subject application, each commenced document processing operation includes performance of both the first level document processing operation and the second level document processing operation.

In yet another embodiment of the subject application, each commenced document processing operation includes performance of only the second level document processing operation.

In a further embodiment of the subject application, the first level document processing operation includes an operation selected from the set including copying, printing, facsimile transmission, electronic mail transmission, scanning, and storage.

In still another embodiment of the subject application, the first level document processing operation includes an operation selected form the set including copying, scanning and printing, and wherein the second level document processing operation includes an operation selected from the set including stapling, hole punching, collating, sheet size selection, page orientation, page setup, output palette selection, output destination, resolution and accounting charges. Preferably, the recognition means includes means adapted for generating numeric data associated with audibly received accounting charge information.

Still further, in accordance with one embodiment of the subject application, there is provided a method for audiovisual control of a document processing device in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1A is an overall diagram of an audiovisual document processing device control system according to one embodiment of the subject application;

FIG. 1B is a close-up view of a user interface associated with the audiovisual document processing device control system according to one embodiment of the subject application;

FIG. 2 is a block diagram illustrating device hardware for use in the audiovisual document processing device control system according to one embodiment of the subject application;

FIG. 3 is a functional diagram illustrating the device for use in the audiovisual document processing device control system according to one embodiment of the subject application;

FIG. 4 is a block diagram illustrating controller hardware for use in the audiovisual document processing device control system according to one embodiment of the subject application;

FIG. 5 is a functional diagram illustrating the controller for use in the audiovisual document processing device control system according to one embodiment of the subject application;

FIG. 6 is a flowchart illustrating a method for audiovisual control of a document processing device according to one embodiment of the subject application; and

FIG. 7 is a flowchart illustrating a method for audiovisual control of a document processing device according to one embodiment of the subject application.

### DETAILED DESCRIPTION OF THE PREFERRED EMBODIMENT

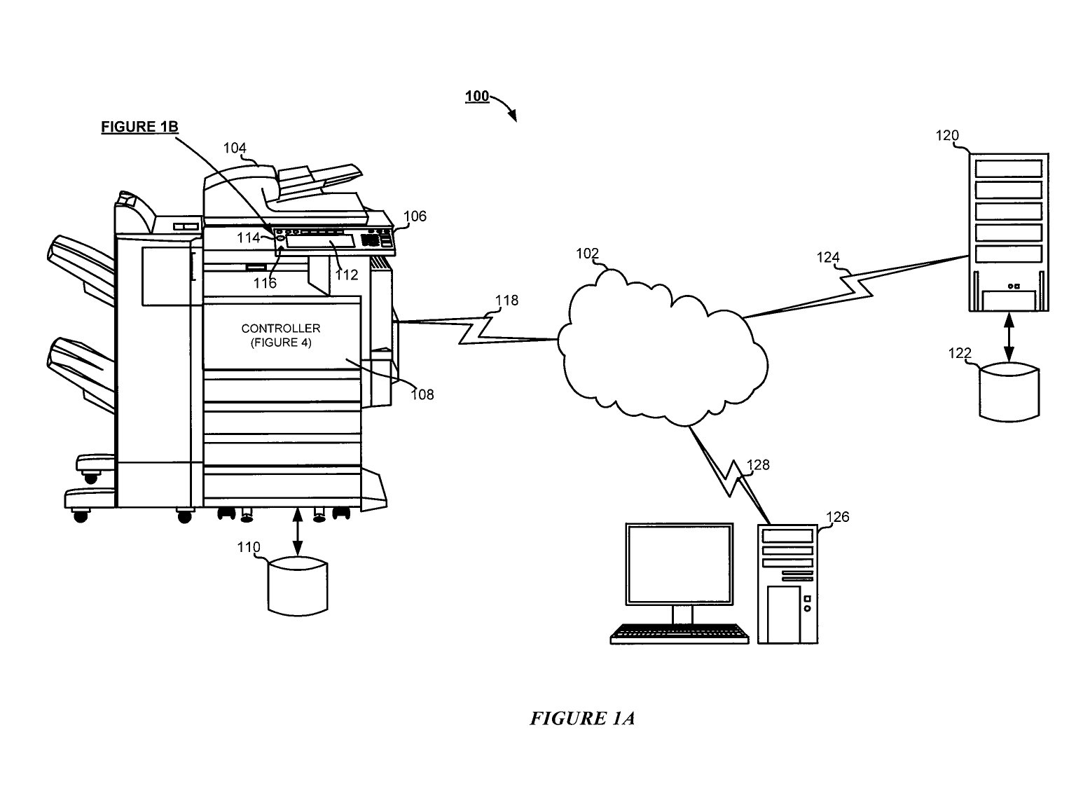

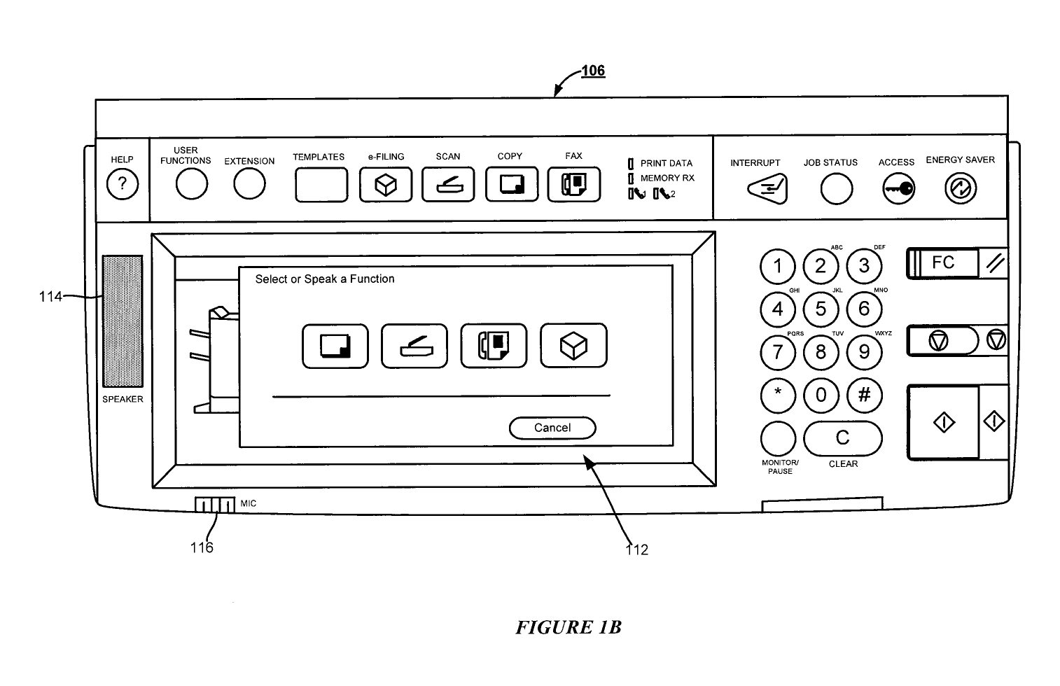

The subject application is directed to a system and method for controlling a document processing device. In particular, the subject application is directed to a system and method for the audiovisual control of a document processing device. More particularly, the subject application is directed to a system and method for efficient user control via a hybridized hierarchical user interface employing speech and graphical user interface input. It will become apparent to those skilled in the art that the system and method described herein are suitably adapted to a plurality of varying electronic fields employing speech and graphical user interface input, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1A, there is shown an overall diagram of an audiovisual document processing device control system 100 in accordance with one embodiment of the subject application. As shown in FIG. 1A, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1A, the subject application is equally capable of use in a stand-alone system, as will be known in the art.

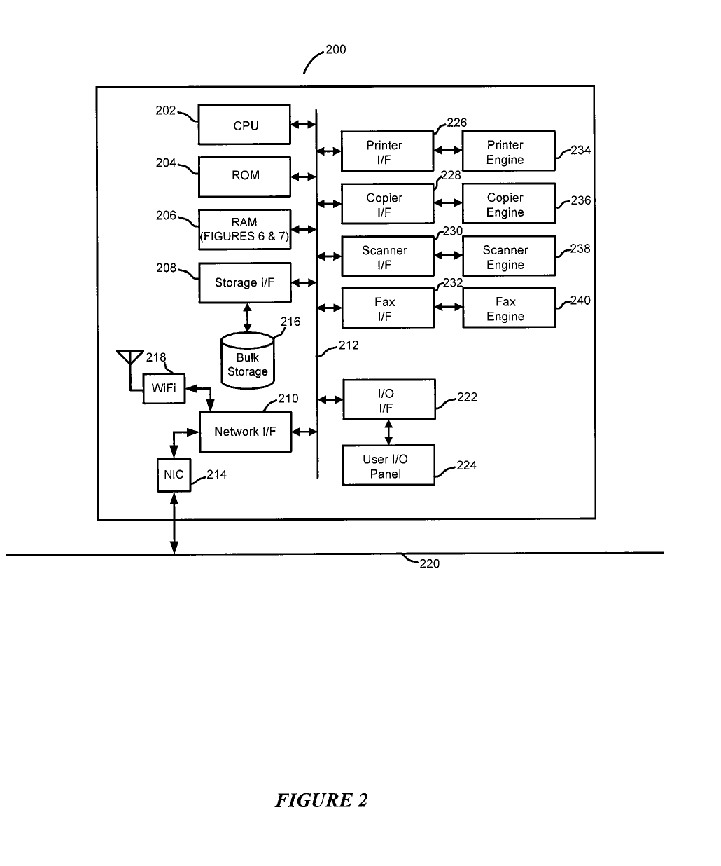

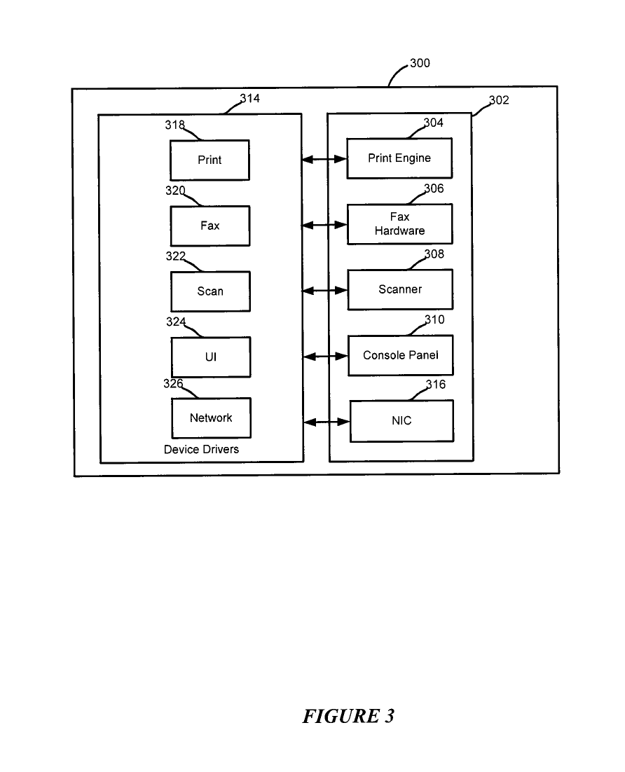

The system 100 also includes a document processing device 104, depicted in FIG. 1A as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like. The functioning of the document processing device 104 will better be understood in conjunction with the block diagrams illustrated in FIGS. 2 and 3, explained in greater detail below.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, an alpha-numeric keypad, speakers, microphones, or the like, via which an associated user is able to interact directly with the document processing device 104.

Turning now to FIG. 1B, there is shown an example user interface 106 associated with the document processing device 104. In accordance with the one embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display 112, suitably adapted to display one or more graphical elements, text data, images, or the like, to an associated user, receive input from the associated user, and communicate the same to a backend component, such as a controller 108, as explained in greater detail below. In addition, the user interface 106 includes a speaker 114 and a microphone 116, suitably configured to audibly send and receive speech communications to an associated user.

Returning to FIG. 1A, the document processing device 104 is preferably in data communication with the computer network 102 via a suitable communications link 118. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

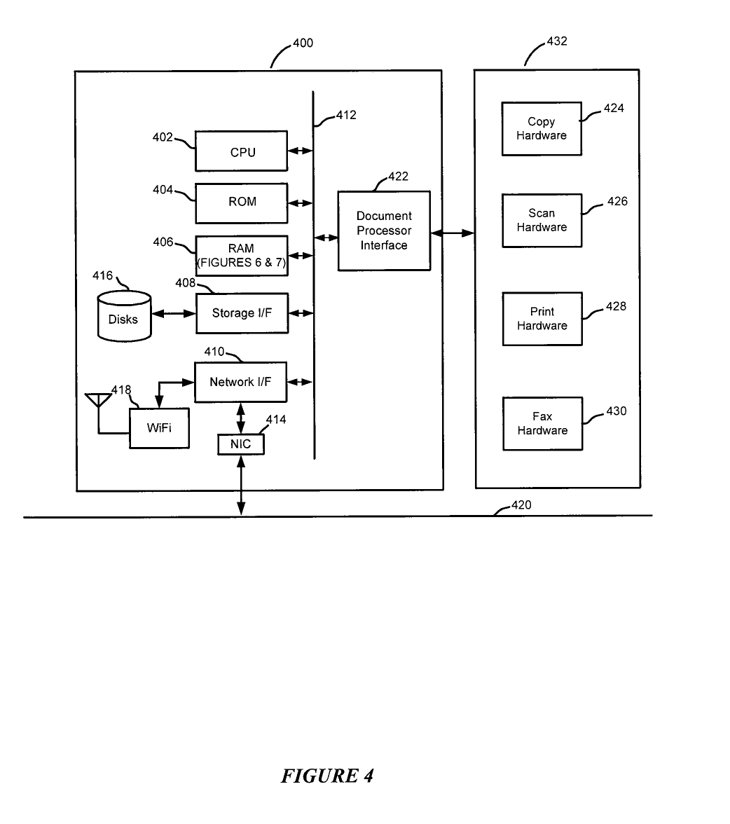

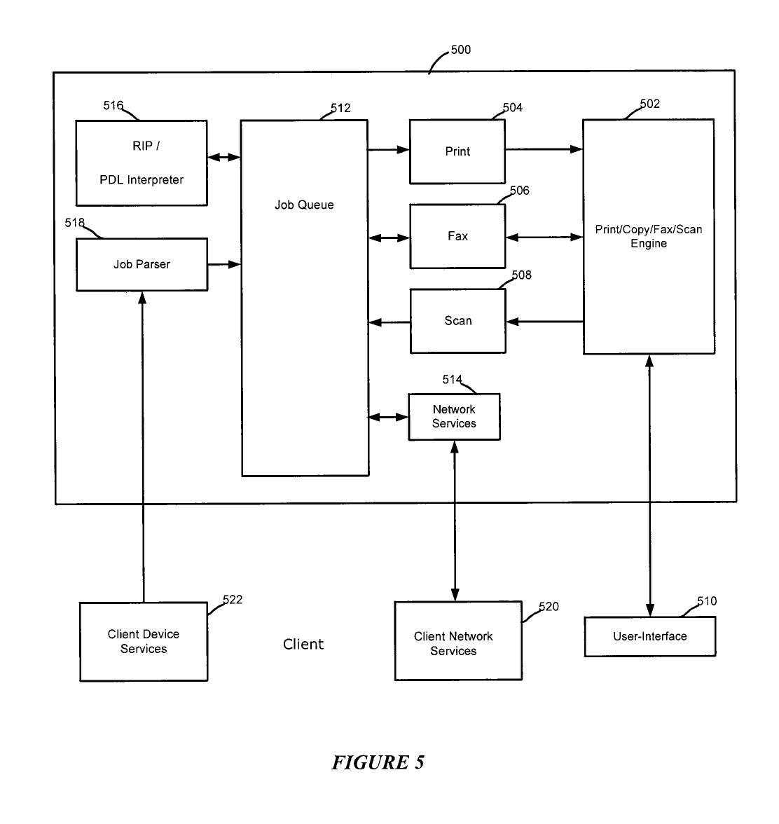

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, send and receive audible communications with an associated user, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for audiovisual control of a document processing device of the subject application. The functioning of the controller 108 will better be understood in conjunction with the block diagrams illustrated in FIGS. 4 and 5, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, image data, electronic database data, or the like, as well as suitable software applications capable of execution by the document processing device 104, e.g., voice recognition software, graphical user interface software, and the like. It will be appreciated by those skilled in the art that while illustrated in FIG. 1A as being a separate component of the system 100, the data storage device 110 is capable of being implemented as internal storage component of the document processing device 104, a component of the controller 108, or the like, such as, for example and without limitation, an internal hard disk drive, or the like.

The system 100 of FIG. 1A further includes a document management system server 120, functioning to facilitate the access, storage, and management of a plurality of devices and documents via the computer network 102 over the communications link 124. According to one embodiment of the subject application, the communications link 124 is capable of securely transmitting and receiving communications via the computer network 102. As will be understood by those skilled in the art, suitable communications links include, for example and without limitation, 802.11a, 802.11b, 802.11g, 802.11(x), Bluetooth, WiMax, infrared, optical, a proprietary communications network, the public switched telephone network, or any suitable wireless data transmission system, or wired communications known in the art.

Preferably, the server 120 is suitably adapted to receive and process a variety of requests received via the computer network 102, including, for example and without limitation, document routing requests, document output requests, document storage requests, electronic mail communications, and the like. As will be appreciated by those skilled in the art, the server 120 is further capable of communicating document data via the computer network 102 to a plurality of devices, such as, for example and without limitation, a computer workstation, a smart phone, a portable data assistant, a document processing device, a facsimile machine, a printer, or the like.

Communicatively coupled to the server 120 is a data storage device 122. In accordance with the preferred embodiment of the subject application, the data storage device 122 is any mass storage device known in the art including, for example and without limitation, magnetic storage drives, a hard disk drive, optical storage devices, flash memory devices, or any suitable combination thereof. In accordance with one embodiment, the data storage device 122 is suitably adapted to store document data, image data, electronic database data, applications, programs, or the like. It will be appreciated by those skilled in the art that while illustrated in FIG. 1A as being a separate component of the system 100, the data storage device 122 is capable of being implemented as internal storage component of the server 120, such as, for example and without limitation, an internal hard disk drive, or the like. Preferably, the server 120 and the data storage device 122 function as a document management system, enabling the creation, storage, management, and processing of a plurality of electronic documents, user accounts, and the like.

The system 100 illustrated in FIG. 1A further depicts a user device 126, in data communication with the computer network 102 via a communications link 128. It will be appreciated by those skilled in the art that the user device 126 is shown in FIG. 1A as a personal computer for illustration purposes only. As will be understood by those skilled in the art, the user device 126 is representative of any personal computing device known in the art, including, for example and without limitation, a computer workstation, a laptop computer, a personal data assistant, a web-enabled cellular telephone, a smart phone, a proprietary network device, or other web-enabled electronic device. The communications link 128 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 126 is suitably adapted to generate and transmit electronic documents, document processing instructions, user interface modifications, upgrades, updates, personalization data, or the like, to the document processing device 104, or any other similar device coupled to the computer network 102, or to receive electronic document data from the document processing device 104, server 120, or other similar devices coupled to the computer network 102.

Turning now to FIG. 2, illustrated is a representative architecture of a suitable device 200, shown in FIG. 1A as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the server 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, shown in FIG. 1A as the document processing device 104, for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1A as the controller 108, on which operations of the subject system 100 are completed. The skilled artisan will understand that the controller 108 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with bus the 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, shown in FIG. 1A as the controller 108, as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

In operation, first level graphical images are generated on an associated video display terminal 112. Preferably, the first level graphical images each uniquely represent an available first level document processing operations capable of being performed by an associated document processing device 104. First audible speech information is then received from an associated user corresponding to a selected first level document processing operation. The selected first level document processing operation is then isolated according to the received first audible speech information. Second level graphical images are then generated on the display terminal 112, with each second level graphical image uniquely representing a second level document processing operation corresponding to the selected first level document processing operation. Second audible speech information is then received from the associated user corresponding to one of the second level document processing operations. The selected one of the available second level document processing operations is then isolated in accordance with the received second audible speech information. A document processing operation is then commenced on the associated document processing device 104 in accordance with the selected first level document processing operation and the selected second level document processing operation.

In accordance with one embodiment of the subject application, suitable first level document processing operations include, for example and without limitation, copying, printing, facsimile transmission, electronic mail transmission, scanning, storage, and the like. Further in accordance with one embodiment of the subject application, second level document processing operations include, for example and without limitation, stapling, hole punching, collating, sheet size selection, page orientation, page setup, output palette selection, output destination, resolution, accounting charges, and the like.

According to one example embodiment of the subject application, first level graphical images are generated on a display 112 of a user interface 106 associated with a document processing device 104. Preferably, the first level graphical images are icons, each associated with a first level document processing operation capable of being performed by the associated document processing device 104. Suitable first level document processing operations capable of being performed by the document processing device 104 include, for example and without limitation, copying, printing, facsimile transmission, electronic mail transmission, scanning, storage, and the like. The user then speaks a name or selects an icon, which is received by the document processing device 104 via the microphone 116, the touch screen display 112, or other user input device of the user interface 106. Preferably, the controller 108 employing software components capable of controlling the display 112, the voice input/output via speaker 114 and microphone 116, a common component enabling communication between the display control and the voice control components, and the like, receives user input of a selected first level document processing operation via the user interface 106.

It will be understood by those skilled in the art that in accordance with one particular embodiment of the subject application, an associated user, via the user device 126, is capable of requesting the performance of document processing operations using a suitable web browser interface via the computer network 102. The skilled artisan will appreciate that in such an embodiment, the user interface associated with the user device 126 facilitates the receipt of user selections and display of operation images to the user.

The controller 108, or other suitable component associated with the document processing device 104, then determines whether the received user input, or first level selection, is an audible input, i.e., the associated user spoke a name associated with a first level document processing operation. When the controller 108 determines that an audible input has been received, the selected first level operation is ascertained from the audible input. It will be appreciated by those skilled in the art that the controller 108, or other suitable component of the document processing device 104, implements voice recognition to retrieve the information regarding the user's selected first level document processing operation. In accordance with one embodiment of the subject application, the document processing device 104 employs a speech recognition engine used to synthesize a user's voice and convert the voice input into data that is interpreted by the document processing device 104 as an operation request or feature request.

The controller 108 then determines the types of second level document processing operation available to the user, based upon the selected first level document processing operation selected by the user. The skilled artisan will appreciate that second level document processing operations available to the user depend upon the type of first level document processing operation selected. That is, the skilled artisan will appreciate that a first level printing operation will include, for example and without limitation, second level operations of stapling, hole punching, collating, and the like, whereas a first level electronic mail transmission operation will not include such second level document processing operations. According to one embodiment of the subject application, second level document processing operations that are capable of being available include, for example and without limitation, stapling, hole punching, collating, sheet size selection, page orientation, page setup, output palette selection, output destination, resolution, accounting charges, and the like.

Once the second level document processing operations available based on the selected first level operation are determined, second level images are generated on the display 112 by the controller 108 via the user interface 106. Preferably, these second level images each uniquely represent one of the available second level document processing operations, for example, a unique icon associated with each second level operation is displayed to the user for selection. User input is then received by the controller 108 via the user interface 106, e.g., via the touch screen display 112, the microphone 116, other input hardware associated with the user interface 106, or a suitable combination thereof. When audible input is received, the second level operation selected by the user is isolated from the speech information received via the microphone 116, so as to determine the desired second level operation. The selected second level document processing operation, whether received via audible or non-audible input, is then added to workflow data representing the document processing operations, first level, second level, and any subsequent levels, selected by the user. As will be understood by those skilled in the art, workflow data is representative of a set of selected document processing operations to be performed for a given document processing request, i.e., a series of operations to be performed by the document processing device 104 resulting in the output of a processed document.

The second level images displayed to the user via the display 112 are then updated, e.g., modified, to reflect the second level document processing operation selected by the user. The user is then able to select additional second level document processing operations from the displayed second level document processing images, which selections are then added to the workflow. It will be understood by those skilled in the art that each selection of a second level document processing operation results in the updating of the display 112 to reflect the selections made by the user.

Once all user selections have been made, e.g., all desired second level document processing operations have been selected, the controller 108 determines whether charges are to be assessed for the performance of the workflow by the document processing device 104. In accordance with one embodiment of the subject application, the user is charged for the performance of document processing services. Thus, when charges are to be assessed, the costs associated with the performance of the requested document processing operations are generated and displayed to the user via the display 112 of the user interface 106. Alternatively, when the document processing request originated from the user device 126, the charges calculated for the performance of the document processing operations by the document processing device 104 are communicated to the user device 126 and displayed to the user thereon. In the event that no charges are to be assessed, the document processing device 104 commences the performance of the selected document processing operations, as set forth by the workflow data, inclusive of the selected first level document processing operation and any selected associated second level document processing operations.

When charges are to be assessed, the document processing device 104 awaits the selection of a payment method by the user, e.g., waits for the user to input appropriate payment data. User input of account data is then received by the controller 108 representative of a prepaid account number, credit card account number, billing account information, or the like. In accordance with this example embodiment of the subject application, the account data is capable of being received as non-audible input data, e.g., manually input data via the display 112 or other input device of the user interface 106, or audible input data, e.g., speech information via the microphone 116. Once the account data has been received, the controller 108 then determines whether the charges have been accepted, e.g., by the user, by confirmation with a payment authority (server 120), or the like. When the charges have been accepted, the document processing device 104 commences the performance of the selected first and second level document processing operations. When the charges are not accepted, the user is capable of inputting an alternate payment method or terminating the document processing request.

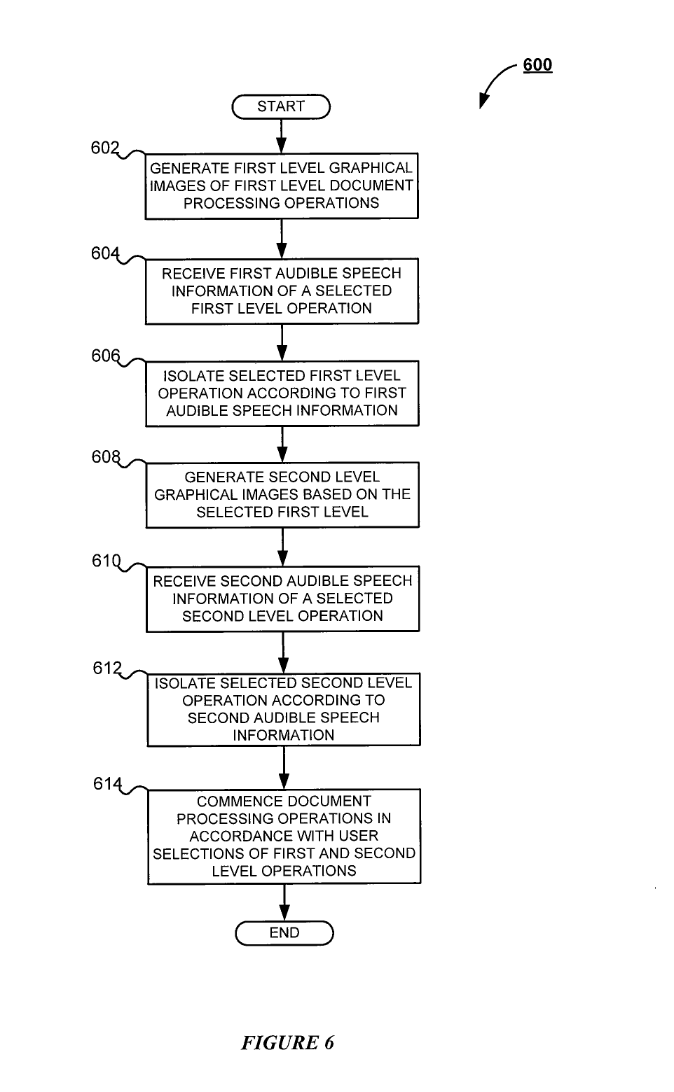

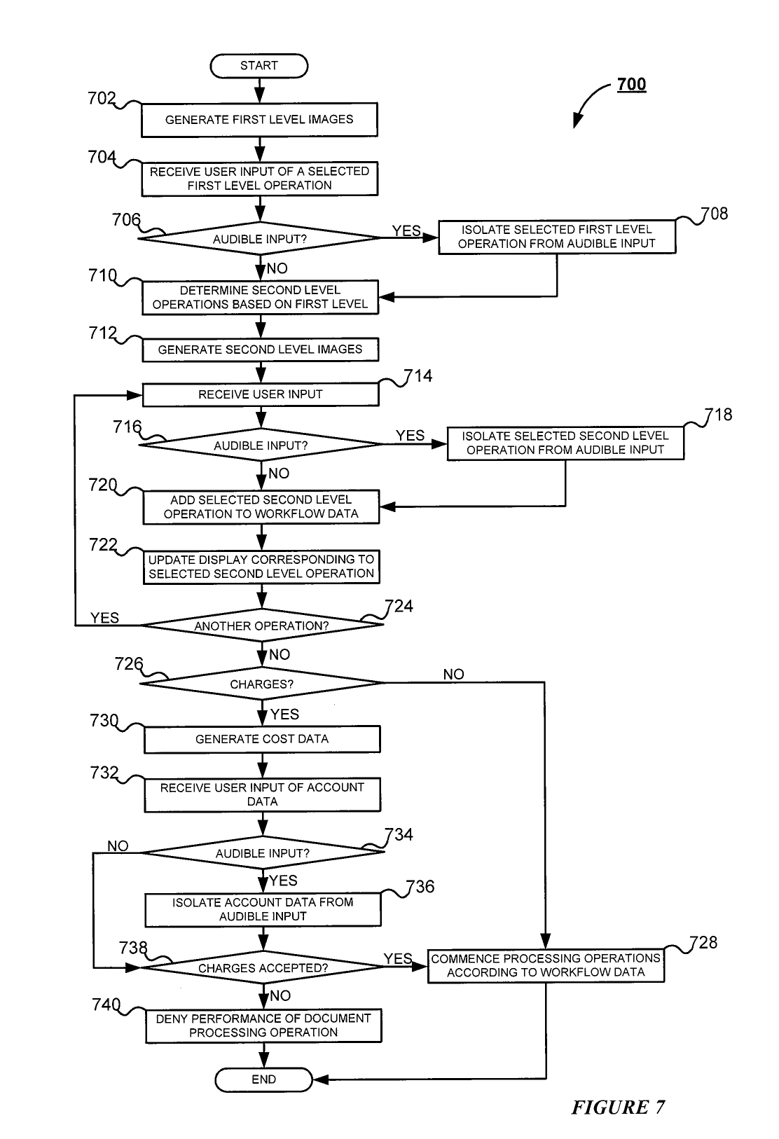

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6 and FIG. 7. Turning now to FIG. 6, there is shown a flowchart 600 illustrating method for audiovisual control of a document processing device in accordance with one embodiment of the subject application. Beginning at step 602, first level graphical images, each uniquely representing one of a plurality of first level document processing operations available, are generated on an associated display terminal. It will be appreciated by those skilled in the art that suitable first level document processing operations include, for example and without limitation, copying, printing, facsimile transmission, electronic mail transmission, scanning, storage, and the like. First audible speech information is then received from an associated user at step 604 corresponding to a selected one of the available first level document processing operations.

At step 606, the selected first level document processing operation is isolated according to the first audible speech information. In accordance with one embodiment of the subject application, a voice recognition component associated with the document processing device 104 analyzes the received audible information and generates appropriate data indicating the selected first level document processing operation. At step 608, second level graphical images are generated based upon the selected first level document processing operation on the associated display 112. Preferably, each second level graphical image uniquely represents a second level document processing function corresponding to the selected first level document processing operation. It will be appreciated by those skilled in the art that the types of second level document processing operations varies in accordance with the type of first level document processing operation selected by the user. Thus, those second level document processing operations available for a printing operation are not necessarily available for an electronic mail transmission operation. Suitable second level document processing operations include, for example and without limitation, stapling, hole punching, collating, sheet size selection, page orientation, page setup, output palette selection, output destination, resolution, accounting charges, and the like.

At step 610, second audible speech information is received from the associated user corresponding to a selected one of the available second level document processing operations. The selected second level document processing operation is then isolated from the received second audible speech information at step 612, so as to ascertain the selected second level document processing operation. Thereafter, at step 614, a document processing operation is commend on an associated document processing device 104 in accordance with the isolated selected first level document processing operation and the isolated selected second level document processing operation.

Referring now to FIG. 7, there is shown a flowchart 700 illustrating method for audiovisual control of a document processing device in accordance with one embodiment of the subject application. The flowchart 700 depicted in FIG. 7 begins at step 702, whereupon first level images, or icons, are generated on the display 112 each icon corresponding to first level document processing operations capable of being performed by the associated document processing device 104. In accordance with one embodiment of the subject application, suitable first level document processing operations include, for example and without limitation, a printing operation, a scanning operation, a storage operation, a facsimile transmission, an electronic mail transmission, a copying operation, or the like. It will be appreciated by those skilled in the art that while the foregoing description references an associated user physically proximate to the document processing device 104, the user is capable of requesting document processing operations remotely, e.g., from the user device 126, or the like. In such an embodiment, data, such as commands, displays, instructions, costs, and the like, are communicated between the user device 126 and the document processing device 104 via the computer network 102.

User input representing a selection of one of the first level icons is then received at step 704. A determination is then made at step 706 whether the user input was an audible input, e.g., user speech information, or non-audible, e.g., user physical interaction with the user interface 106 (touch screen display 112, alphanumeric keypad, dedicated hardware button, or the like). When the user input is determined to be an audible input, flow proceeds to step 706, whereupon the first level operation selected by the user is isolated in accordance with the speech information received from the user. Preferably, the document processing device 104 employs a voice recognition component, as will be understood by those skilled in the art, to receive and process voice input received via the microphone 114 and convert this voice input into an appropriate format for further processing by the controller 108. Flow then proceeds to step 710, whereupon the second level document processing operations available in accordance with the received first level operation selection are determined.

Similarly, flow proceeds to step 710 from step 706 when it is determined that non-audible user input is received by the document processing device 104. That is, when the user selects a first level document processing operation using non-audible means, e.g., touch screen selection, hardware button selection, etc., flow progresses from step 706 to step 710. Once the first level document processing operation selected by the user is determined, the corresponding second level document processing operations associated with the first level operation are determined. It will be appreciated by those skilled in the art that suitable second level document processing operations include, for example and without limitation, stapling, hole punching, collating, sheet size selection, page orientation, page setup, output palette selection, output destination, resolution and accounting charges. The skilled artisan will further appreciate that second level document processing operations available for one first level document processing operation may not be available for another first level document processing operation. For example, copying and printing are capable of including stapling, hole punching, or the like, whereas electronic mail transmission or storage operations will not include these functions, as the output from these operations cannot incorporate stapling, hole punching, or the like.

Second level images are then generated at step 712 corresponding to the available second level document processing operations on the display 112, with each image, or icon, uniquely corresponding to a specific second level document processing operation associated with the first level document processing operation. User input is then received at step 714 representing a desired second level document processing operation. A determination is then made at step 716 whether the user input is audible or non-audible input. When it is determined that an audible input has been received, flow proceeds to step 718, whereupon the second level document processing operation is isolated from the audible input, so as to determine which of the available second level operations has been selected by the user. When non-audible input is determined to have been received, flow proceeds to step 720, whereupon the selected second level document processing operation is added to workflow data representing all selected document processing operations. It will be appreciated by those skilled in the art that step 720 occurs irrespective of whether audible or non-audible input is received from the user. After adding the selected second level document processing operation to the workflow, the display 112 of second level images is updated at step 722, so as to indicate the selected second level document processing operation. The skilled artisan will appreciate that any means of updating the display 112 is capable of being employed herein, including, for example and without limitation, modifying the corresponding icon, e.g., highlighting, underlining, bolding, shading, removing, or the like.

A determination is then made at step 724 whether or not the user desires to add an additional second level document processing operation. For example, when the first level operation is a printing operation, the user may desire to add stapling and hole punching as second level document processing operations. When an additional second level operation is desired, flow returns to step 714, whereupon user input is received corresponding to the additional second level document processing operation. Operations continue thereon as set forth above with respect to steps 714-724. When no additional second level operations are desired, flow proceeds to step 726, whereupon a determination is made whether the performance of the requested document processing operations necessitate the payment of any costs by the associated user. That is, whether or not the user is required to pay for the performance of the document processing operations. When no payment is required, flow proceeds to step 728, whereupon the document processing device 104 commences the performance of the requested document processing operations in accordance with the workflow data.

When it is determined at step 726 that charges are necessitated, flow proceeds to step 730, whereupon the costs associated with the performance of the selected document processing operations are calculated and a display illustrating the cost is generated, via the display 112, to the user. It will be appreciated by those skilled in the art that when the user is remotely requesting document processing operations, the cost data is communicated to the user device 126 via the computer network 102 and displayed to the user via the user interface associated with the user device 126. User input is then received at step 732 corresponding to payment or account data for payment of the charges calculated at step 730. A determination is then made at step 734 whether the user input is an audible input or a non-audible input. That is, whether the user has spoken payment data, numeric account information, user name, billing information, or the like, or has typed, swiped (credit card, prepaid card, etc.) payment data.

A determination at step 734 that audible input has been received prompts the isolation of the account data from the audible input at step 736. Preferably, a voice recognition component associated with the document processing device isolates the account information from the spoken user input. Once the account data has been received, either audibly or non-audibly, flow proceeds to step 738, whereupon a determination is made whether the charges have been accepted. That is, a determination is made whether the payment data is valid, the user accepts the charges, confirmation of the charges has been received, or the like. The skilled artisan will appreciate that when using a prepaid account, the document processing device 104, or a suitable component thereof, communicates prepaid account information to a backend device, e.g., server 120, for validation. Upon validation, or acceptance of the charges, flow proceeds to step 728, whereupon the document processing device 104 commences document processing operations in accordance with the workflow data, i.e., the selected first level document processing operation and any selected second level document processing operations. When the charges are not accepted at step 738, flow proceeds to step 740, whereupon the requested document processing operations are denied and operations set forth in FIG. 7 terminate.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. An audiovisual document processing device control system comprising:
means adapted for generating, on an associated video display terminal, a plurality of first level graphical images, each first level graphical image being uniquely representative of at least one of a plurality of available first level document processing operations;
means adapted for receiving first audible speech information from an associated user, which first audible speech information corresponds to a selected one of the available first level document processing operations;
recognition means, the recognition means including means adapted for isolating the selected one of the available first level document processing operations in accordance with received first audible speech information;
means adapted for generating, on the associated video display terminal, a plurality of second level graphical images, each second level graphical image being uniquely representative of at least one of a plurality of available second level document processing operations corresponding to the selected first level document processing operation;
means adapted for receiving second audible speech information from the associated user, which second audible speech information corresponds to a selected one of the available second level document processing operations;
the recognition means further including means adapted for isolating the selected one of the available second level document processing operations in accordance with received second audible speech information; and
means adapted for commencing a document processing operation on an associated document in accordance with an output of the recognition means.

2. The audiovisual document processing device control system of claim 1 further comprising means adapted for receiving non-audible user selection data corresponding to each of the selected first level document processing operation and the second level document processing operation such that the associated user is enabled for alternative selection via audible and non-audible input.

3. The audiovisual document processing device control system of claim 1 wherein each commenced document processing operation includes performance of both the first level document processing operation and the second level document processing operation.

4. The audiovisual document processing device control system of claim 1 wherein each commenced document processing operation includes performance of only the second level document processing operation.

5. The audiovisual document processing device control system of claim 1 wherein the first level document processing operation includes an operation selected from the set including copying, printing, facsimile transmission, electronic mail transmission, scanning and storage.

6. The audiovisual document processing device control system of claim 1 wherein the first level document processing operation includes an operation selected from the set including copying, scanning and printing, and wherein the second level document processing operation includes an operation selected from the set including stapling, hole punching, collating, sheet size selection, page orientation, page setup, output palette selection, output destination, resolution and accounting charges.

7. The audiovisual document processing device control system of claim 6 wherein the recognition means includes means adapted for generating numeric data associated with audibly received accounting charge information.

8. A method for audiovisual control of a document processing device comprising the steps of:
generating, on an associated video display terminal, a plurality of first level graphical images, each first level graphical image being uniquely representative of at least one of a plurality of available first level document processing operations;
receiving first audible speech information from an associated user, which first audible speech information corresponds to a selected one of the available first level document processing operations;
isolating the selected one of the available first level document processing operations in accordance with received first audible speech information;
generating, on the associated video display terminal, a plurality of second level graphical images, each second level graphical image being uniquely representative of at least one of a plurality of available second level document processing operations corresponding to the selected first level document processing operation;
receiving second audible speech information from the associated user, which second audible speech information corresponds to a selected one of the available second level document processing operations;
isolating the selected one of the available second level document processing operations in accordance with received second audible speech information; and
commencing a document processing operation on an associated document in accordance with an output of the step of isolating the selected one of the available first level document processing operations and the selected one of the available second level document processing operations.

9. The method for audiovisual control of a document processing device of claim 8 further comprising the step of receiving non-audible user selection data corresponding to each of the selected first level document processing operation and the second level document processing operation such that the associated user is enabled for alternative selection via audible and non-audible input.

10. The method for audiovisual control of a document processing device of claim 8 wherein each commenced document processing operation includes performance of both the first level document processing operation and the second level document processing operation.

11. The method for audiovisual control of a document processing device of claim 8 wherein each commenced document processing operation includes performance of only the second level document processing operation.

12. The method for audiovisual control of a document processing device of claim 8 wherein the first level document processing operation includes an operation selected from the set including copying, printing, facsimile transmission, electronic mail transmission, scanning and storage.

13. The method for audiovisual control of a document processing device of claim 8 wherein the first level document processing operation includes an operation selected from the set including copying, scanning and printing, and wherein the second level document processing operation includes an operation selected from the set including stapling, hole punching, collating, sheet size selection, page orientation, page setup, output palette selection, output destination, resolution and accounting charges.

14. The method for audiovisual control of a document processing device of claim 13 further comprising the step of generating numeric data associated with audibly received accounting charge information.

15. A computer-implemented method for audiovisual control of a document processing device comprising the steps of:
generating, on an associated video display terminal, a plurality of first level graphical images, each first level graphical image being uniquely representative of at least one of a plurality of available first level document processing operations;
receiving first audible speech information from an associated user, which first audible speech information corresponds to a selected one of the available first level document processing operations;
isolating the selected one of the available first level document processing operations in accordance with received first audible speech information;
generating, on the associated video display terminal, a plurality of second level graphical images, each second level graphical image being uniquely representative of at least one of a plurality of available second level document processing operations corresponding to the selected first level document processing operation;
receiving second audible speech information from the associated user, which second audible speech information corresponds to a selected one of the available second level document processing operations;
isolating the selected one of the available second level document processing operations in accordance with received second audible speech information; and
commencing a document processing operation on an associated document in accordance with an output of the step of isolating the selected one of the available first level document processing operations and the selected one of the available second level document processing operations.

16. The computer-implemented method for audiovisual control of a document processing device of claim 15 further comprising the step of receiving non-audible user selection data corresponding to each of the selected first level document processing operation and the second level document processing operation such that the associated user is enabled for alternative selection via audible and non-audible input.

17. The computer-implemented method for audiovisual control of a document processing device of claim 15 wherein each commenced document processing operation includes performance of both the first level document processing operation and the second level document processing operation.

18. The computer-implemented method for audiovisual control of a document processing device of claim 15 wherein each commenced document processing operation includes performance of only the second level document processing operation.

19. The computer-implemented method for audiovisual control of a document processing device of claim 15 wherein the first level document processing operation includes an operation selected from the set including copying, printing, facsimile transmission, electronic mail transmission, scanning and storage.

20. The computer-implemented method for audiovisual control of a document processing device of claim 15 wherein the first level document processing operation includes an operation selected from the set including copying, scanning and printing, and wherein the second level document processing operation includes an operation selected from the set including stapling, hole punching, collating, sheet size selection, page orientation, page setup, output palette selection, output destination, resolution and accounting charges.
